(19) United States
(12) Patent Application Publication
(10) Pub. No.: US 2004/0013250 A1
(43) Pub. Date: Jan. 22, 2004

(54) System and method of tracking component object requests

(76) Inventors: Sreekrishna Kotnur, Bangalore (IN); Sasank Kotnur, Bangalore (IN)

Correspondence Address: Welsh & Katz, Ltd., 22nd Floor, 120 South Riverside Plaza, Chicago, IL, 60606, US

(21) Appl. No.: 10/200,409

(22) Filed: Jul. 22, 2002

(51) Int. Cl. H04M 15/00

(52) U.S. Cl. 379/112.01; 379/111

(57) ABSTRACT

A computing system capable of tracking computer calls is provided. The computing system may include a call tracker, a code generator responsive to the call tracker, the code generator configured to generate computer tracking code and to provide the tracking code to the call tracker, a software component responsive to the call tracker, the software component configured by the tracking code to extract call details and to provide a reporting code to the call tracker; and a call logger responsive to the call tracker, the call logger configured to store extracted call details. A software application may be used in communication with the call tracker and the software component. The computing system may be a single computer or a plurality of computers interconnected by a network. A software component configured with the tracking code may be configured to generate a reporting code to report the details of a component call to the call tracker. The reporting code may be a string of predetermined fields of information pertaining to a tracked call, and may include such details as the selected component name, the bind name, and the requested method or function.

### FIELD OF THE INVENTION

The present invention relates generally to a system and method of controlling software components using object oriented programming. More particularly, the invention pertains to a system and method of tracking component object requests in a computing system during runtime.

### BACKGROUND OF THE INVENTION

The ability to build new and improved software efficiently has been the goal of many software firms. Over the past decades, significant advancements have been made to address these needs, leading to new and easier programming languages, improved database systems and significant improvements in component or object oriented techniques. One such improvement has been the advent of component based development/programming techniques.

Component based programming or development generally includes writing or developing smaller objects or components, which perform specific tasks or functions. The smaller components are integrated with other components to form a larger component or application capable of the tasks or functions of its constituent components. Component based development has enabled true implementation of one of the object-oriented techniques, namely, “reusability.” Reusability reflects the ability to reuse previously-written software components to create new applications. Building software from components means creating an application in whole or in part from existing components rather than starting anew each time.

The use of software component technology is greatly prevalent in distributed computing environments or systems. Distributed computing environments can have a plurality of computing environments, which may be in electronic communication by way of a computer network. In a distributed computing environment, different components, which can be disbursed over a network of computers, generally perform different tasks.

Different components may be provided by different vendors and created in different programming languages. Also, because of the remoteness of the components, i.e. not located on the same machine, it can be difficult to control the components.

These components or applications can malfunction for a variety of reasons, such as memory overload. Such malfunctions may cause other components or applications within the network to malfunction as well, potentially causing the entire network or system to malfunction. Because of this, a need exists for the user to know which components are communicating with each other. This information can be beneficial in diagnosing behavior of components in the system.

The ability to program an application to inform a user of the applications' operating status and their memory usage is generally known. However, it is not known how to at runtime automatically inform a user of calls and requests being made between each of the components without requiring the user to manually program the components with a code to enable object calls to be tracked. Therefore, the ability to monitor the calls made between the components and/or applications can be an invaluable mechanism which would enable a user to track the performance of component and select a method or component to deactivate or stop before malfunction or system overload.

Accordingly, there exists a need for a system and method of dynamically tracking component object calls and requests at runtime over a network or system. It is desirable that such method and system automatically generates a computer readable software program or code that enables components with the specific code to track calls transmitted and received by the components, without requiring the user to manually program the components. It is further desirable that such system and method be capable of accessing a variety of components residing on different platforms and/or using different operating systems.

### SUMMARY OF THE INVENTION

A computing system capable of tracking computer calls is provided. The computing system may include a call tracker, a code generator responsive to the call tracker, the code generator configured to generate computer tracking code and to provide the tracking code to the call tracker, a software component responsive to the call tracker, the software component configured by the tracking code to extract call details and to provide a reporting code to the call tracker; and a call logger responsive to the call tracker, the call logger configured to store extracted call details. A software application may be used in communication with the call tracker and the software component. The computing system may be a single computer or a plurality of computers interconnected by a network. A software component configured with the tracking code may be configured to generate a reporting code to report the details of a component call to the call tracker. The reporting code may be a string of predetermined fields of information pertaining to a tracked call, and may include such details as the selected component name, the bind name, and the requested method or function.

A method of tracking computer call requests may comprise the steps of configuring the computing system to include a call tracker, a code generator responsive to the call tracker, a call logger responsive to the call tracker, and one or more components in responsive communication with the call tracker, searching for and selecting a component, sending details of the selected component to the call tracker. The call tracker may then parse the details and invoke the code generator. The code generator may generate a tracking code to extract call details send the tracking code to the call tracker. The call tracker may install the tracking code in the selected software component. Once the tracking code is installed, the software component may report call details to the call tracker. A call logger may the log the call details.

### BRIEF DESCRIPTION OF THE DRAWINGS

The various objects and advantages of the present invention will become apparent to those of ordinary skill in the relevant art after reviewing the following detailed description and accompanying drawings, wherein:

FIG. 1a is a block diagram of a system for tracking component object calls in accordance with one embodiment of the present invention;

FIG. 1b is a block diagram of a system for tracking object calls in accordance with another embodiment of the present invention.

FIG. 2 is a flow diagram illustrating one example of generating a tracking code and transferring the tracking code to the component;

FIG. 3 is a flow diagram illustrating one example of tracking object calls by inserting the tracking code in the component and logging the details of the call;

FIG. 4 is a flow diagram illustrating another example of tracking object calls;

FIG. 5 is a flow diagram illustrating one example of logging tracked calls;

FIG. 6 is a flow diagram illustrating one example for retrieving the call detail logs of tracked calls.

### DETAILED DESCRIPTION OF THE INVENTION

While the present invention may be practiced in various forms, there is shown in the drawings and will hereinafter be described a presently preferred embodiment with the understanding that the present disclosure is to be considered an example of the invention and is not intended to limit the invention to the specific example illustrated. It should be further understood that the title of this section of this specification, namely, “Detailed Description Of The Invention”, relates to a requirement of the United States Patent Office, and does not imply, nor should be inferred to limit the subject matter disclosed herein.

In the present disclosure, the words “a” or “an” are to be taken to include both the singular and the plural. Conversely, any reference to plural items shall, where appropriate, include the singular.

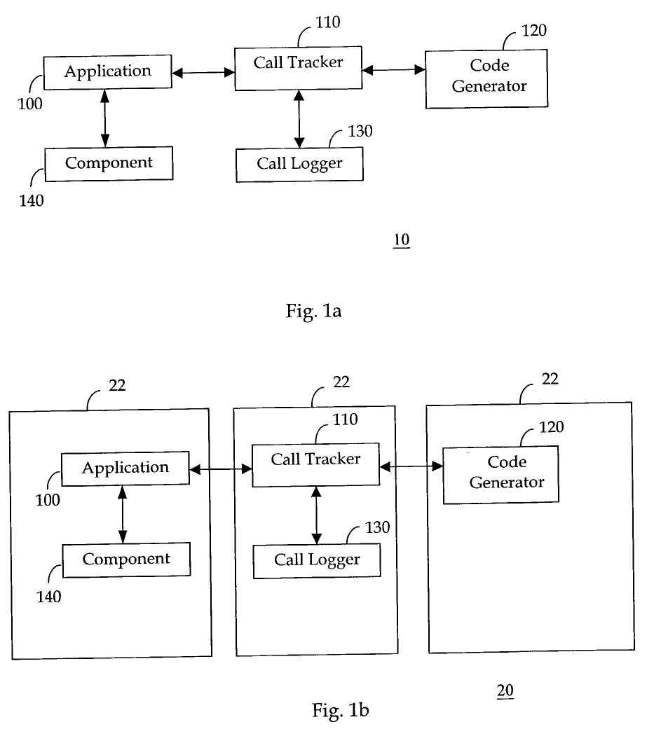

Referring now to FIG. 1a, a there is shown a block diagram illustrating one example of a Computing System 10 configured for tracking object request calls between software components in the computing system, in accordance with one embodiment of the present invention. The Computing System 10 is configured to track transmissions or calls between one or more Software Components 140 and/or one or more Applications 100 in a computing system. The Computing System 10 in FIG. 1a may be a single computer. FIG. 1b illustrates another example of a Computing System 20 comprising a plurality of computers 22 interconnected by a network. In both examples, the Computing System 10, 20 includes an Application 100, a Software Component 140, a Call Tracker 110, a Code Generator 120, a Call Logger 130, and a Storage Repository 150. In the example, illustrated in FIG. 1b, the various parts of the Computing System 20 are distributed across more than one individual computer. As used herein, reference to “Computer System” refers generally to both examples of Computer System 10, 20, and is not intended to exclude Computer System 20.

The Software Component 140 is in coupled communication with the Call Tracker 110 via either an Application 100, other associated entities or via direct connection with the Call Tracker 110. The Software Component 140 may be a publishing component or a subscribing component. Within typical object oriented networks or computing environments, a subscribing component may request a method or function from a publishing component. By obtaining the requested method, the subscribing component is provided with the capabilities to perform the requested function or task.

A Software Component 140 that is a subscribing component is selected (by the user or automatically) to have its calls or requests tracked. To track the requests between the Software Components 140 and other entities, the Computing System 10 configures the Software Component 140 with a specific tracking code which tracks the calls or requests generated from the Software Component 140. The tracking code may be a portion of software code or a computer program. It is contemplated that this tracking function can be performed during runtime of the Software Component 140 and that the specific tracking code can be generated by an associated application, and/or on the component or generated by the Code Generator 120.

Using the tracking code, the Call Tracker 110 parses the call's attributes and transfers selected call information to the Call Logger 130, which logs or records the call information in a database. The selected call information may also be stored in a flat file. Call information that is recorded and logged may include, for example, information about the Software Component 140 placing the call or request, information about another Software Component 140 which is a subscribing component receiving the request or call, the date and/or time of the call, the name of the function or method requested, and the signature and/or parameters of the function or method requested. Other information may be selected for call information as desired.

The Call Tracker 110 tracks calls and/or transmissions sent between the Software Components 140 deployed or registered with the Computing System 10. The Call Tracker 110 can be a server or similar type of processing apparatus. The Call Tracker 110 may be coupled in communication with one or more clients. The clients generally have Applications 100 which enable the client to perform various tasks or functions. The Call Tracker 110 receives information from the Application 100 or an associated database to provide information, such as the attributes of the Software Components 140 registered with the Computing System 10, such that the user or Computing System 10 can make a determination one or more Software Components 140 to configure for call tracking. The Call Tracker 110 is configured for controlling associated mechanisms in the Computing System 10.

The clients may exist on a singular network or may be distributed across one or more heterogeneous networks. The clients may be distributed stubs of the Call Tracker 110 as well the Call Logger 130, Code Generator 120, Storage Repository 150, and other local and/or distributed components in communication.

The Code Generator 120 generates a tracking code that is eventually transferred to the Software Component 140. The tracking code configures the Software Component 140 to capture and report the details of its calls to the Application 100 or to the Call Tracker 110. This enables the Computing System 10 to track calls initiated and received by Software Components 140 in the computing system. The Code Generator 120 generates a suitable tracking code by reading details corresponding to the selected Software Component 140 and generating a code that compiles information about the call, such as the selected component and the method to be performed.

The Call Logger 130 includes a database or similar structure for managing, maintaining, or storing a call log that contains details of the tracked calls. The Call Logger 130 parses the details of the call and creates a call identification or I.D. The call identification information may contain information such as the name of the subscribing Software Component 140 (the component placing the call), the name of the publishing Software Component 140 (the component receiving the call), the date and time of the call, the name of the transferred method or function, as well as that method's name, signatures and parameters. The Call Logger 130 compiles the details of call identification information. The call identification information may be designated a sequence number (a unique number that is an indicator of the number of the call that has been tracked) to form the I.D. The Call Logger 130 then selects a Storage Repository 150 or some other suitable persistent storage container to store the call identification information for later retrieval.

In one embodiment illustrated in FIG. 1b, the Call Tracker 110, the Code Generator 120 and the Call Logger 130 may independently reside on different computers within the Computing System 20. In another embodiment illustrated in FIG. 1a, the Application 100 and the Software Component 140 may reside on the same computer. The Software Component 140, Call Tracker 110, Code Generator 120, Application and Storage Repository 150 may reside on different operating systems and/or networks as well as other entities other than those existing on the Computing System 10, 20.

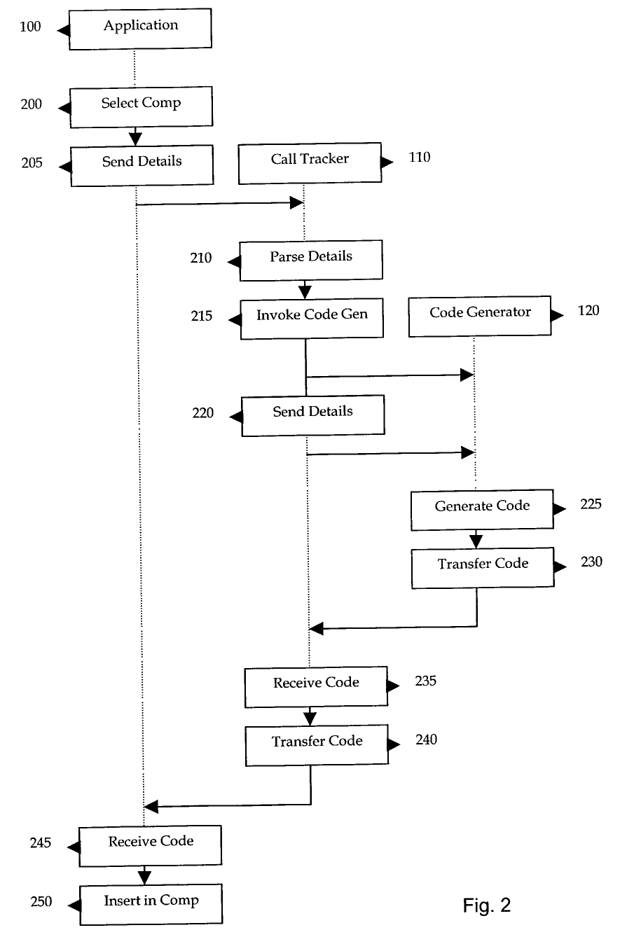

Referring now to FIG. 2, there is shown an example for generating the tracking code. The Application 100 accesses a list or database of Software Components 140 deployed or registered with the Computing System 10. This information can be either stored and maintained by the Application 100 or accessed from an associated server or database associated with the Computing System 10. After accessing the information or details pertaining to the Software Components 140, the Application 100, Call Tracker 110 or another entity provides a list of Software Components 140 deployed or registered with the Computing System 10 to the user or the Computing System 10. This information can be compiled and transferred using a user interface such as a textual display, audible speaker, or any other like mechanism generally known to those skilled in the art that enables a user to receive data or information. Using the interface, the user selects one or more Software Components 140 to track, usually subscribing components.

The criteria for selecting the Software Component 140 varies. Selection may be made, for example, by random choice, based on specific factors, such as, but not limited to, the memory load on the subscribing Software Component 140, the functions or methods performed by the subscribing Software Component 140, or the operating system of the Software Component 140, or by preference of a computer user.

The Call Tracker 110 may automatically select a desired Software Component 140 to track. In this example, the Call Tracker 110 is configured to automatically search specific directories/folders to search for a desired Software Component 140. The search for a desired Software Component 140 can be done by accessing either the same or different machines that Software Components 140 are stored. After the Call Tracker 110 or User locates and selects one or more Software Components 140 to track, the Code Generator 120 generates a tracking code for the Software Component 140.

In another example, the Call Tracker 110 automatically selects which Software Component 140 to track. The Call Tracker 110 is configured to parse directories/folders on different or the same machines where the Software Components 140 are stored or information about the Software Component 140 is stored. The Call Tracker 110 automatically detects the Software Components 140 and requests the Code Generator 120 to generate a tracking code. The tracking code can be transferred into the component's source file either manually or automatically. When additional new components are added to the Computing System 10, the Call Tracker 110 and Call Generator 120 automatically are triggered to generate tracking code for them.

In an example of configuring a Software Component 140 with a the tracking code, the Application 100 reads the details of the selected subscriber Software Component 140 and sends the details to the Call Tracker 110. The component details may include information such as the name of the Software Component 140, the path of the Software Component 140, the source file name of the Software Component 140, the bind name of the Software Component 140 and any other configurable details. Typically the component details are transmitted in a code string.

The Call Tracker 110 receives the component details of the Software Component 140 and parses the component details, placing the information into a predetermined format. The component details may be separated into specific categories such as Component Name, bind Name, Path IP Address. Other details may also be used depending on the system. For example, X.25 and frame delay networks have details other than IP address that may be used. The Call Tracker 110 may create a temporary component detail object for storing these details. The component detail object may be any type of data object or data structure or database capable of storing and/or holding the details of the Software Component 140. The component detail object stores the details until a tracking code is successfully generated. The component details of the selected Software Component 140 may also be written into a persistent storage for long-term storage, if desired.

The Call Tracker 110 is in coupled communication with the Code Generator 120. The Call Tracker 110 contacts the Code Generator 120 and notifies the Code Generator 120 of the component details of the selected Software Component 140. After establishing a connection with the Code Generator 120, the Call Tracker 110 invokes the Code Generation mechanism of the Code Generator 120 and sends the details held in the component detail object to the Code Generator 120. Based on these component details, the Code Generator 120 generates a tracking code for tracking and recording details of request being made by the Software Component 140. The tracking code created by the Code Generator 120 is configured to trap or record requests that may be made by the Software Component 140.

Illustrated below is one example of a tracking code generated by the Call Generator 120 and sent to the Software Component 140. The tracking code contains methods and/or functions that can trace a call made by a subscribing Software Component 140 to a publishing Software Component 140 containing this code (or calls on the publisher for which this code is specifically generated).

com.obj.se.server.CallTracker.TraceClientCalls.setMethodCall
(super.getAvailerBindName( ),“MethodOne(java.lang.String

$param0,java.lang.String $param1)”,getProviderBindName( ),true);

return instance.MethodOne($param0,$param1);
}

else {

com.obj.se.server.TraceClientCalls.setMethodCall
(super.getAvailerBindName( ),“MethodOne(java.lang.String

$param0,java.lang.String $param1)”,getProviderBindName( ),false);

throw new java.rmi.RemoteException
(“Method Access Denied : not Configured to access ”);

}

}

In this example the “com.obj.se.server” represents the middleware library path of the middleware/Application. The “setMethodCall” tracks the calls being made on the object. The “com.obj.se.server” is the middleware library path of the middleware/Application. The “setMethodCall” tracks the calls being made on the object.

When a Software Component 140 (a subscribing component) calls on another Software Component 140 (a publishing component), this code is invoked and the “TraceClientCalls.setMethodCall( )” method of the Call Tracker 110 is invoked. The “setMethodCall” is a derived method of the TraceClientCalls class' setMethodCa( ) method. The “setMethodCall( )” contains the methods published by the publishing Software Components 140, which are chosen to be monitored or tracked.

When the subscribing Software Component 140 calls upon an object of the publishing Software Component 140, the setMethodCa( ) traps the call and returns the call information to the TraceClientCalls.setMethodCall( ) method of the CallTracker. The setMethodCa( ) in the CallTracker's TraceClientCalls class contains the computation to keep a log of all the calls being made by different subscribers on each of the instance of the publisher for the published methods of the publisher. Although the above example is provided for clarity, the invention is not limited to the above example of software code.

The Code Generator 120 also creates a reporting code that reports the extracted details of the calls, which is transmitted to the subscribing Software Component 140. The reporting code is sent from the Code Generator 120 to the Call Tracker 110. The reporting code is parsed by the Call Tracker 110 and transferred to a persistent storage environment or storage repository (not shown).

Upon the successful completion of the code generation process, the code is transferred to the Software Component 140. The Code Generator 120 establishes communication with the Call Tracker 110 and transfers the tracking code to the Call Tracker 110. The Call Tracker 110 receives the tracking code and transfers the code to the, Software Component 140 selected for tracking via the Application 100 or other entities. The Application 100 receives the tracking code and inserts the code into the selected Software Component 140.

In another example, the Call Tracker 110 is in direct communication with the selected Software Component 140. In this example of the invention, the Call Tracker 110 transfers the tracking code directly to the Software Component 140 instead of transferring the tracking code through the Application 100.

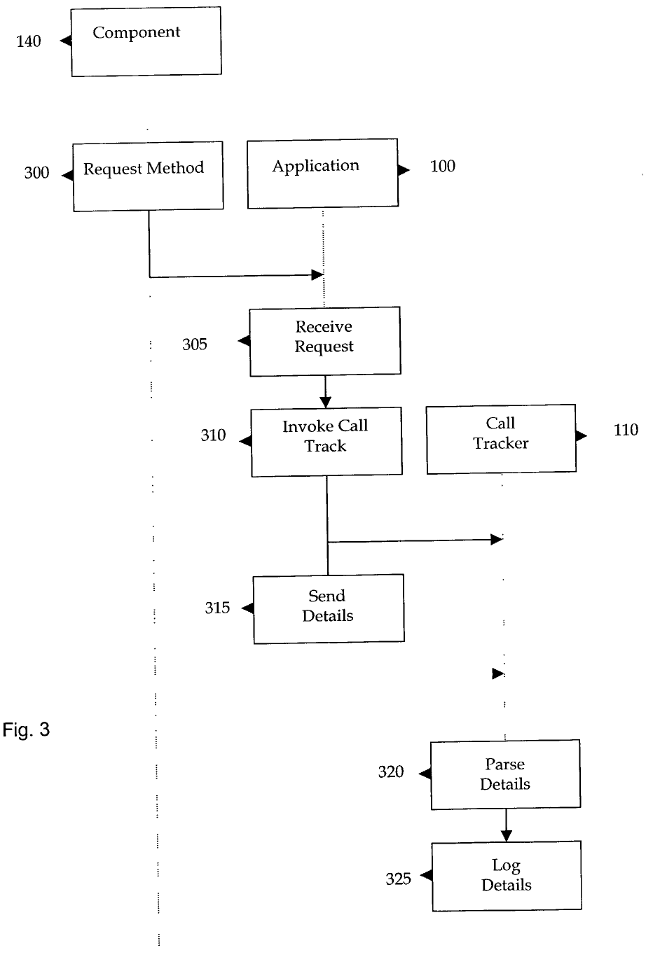

FIG. 3 illustrates one example for tracking calls by the Computing System 10, 20. In this example, a Software Component 140 requests the Application 100 to retrieve a method or task from a publishing Software Component 140 registered with the Computing System 10, 20. The Application 100 contacts the Call Tracker 110 and sends the Call Tracker 110 call details. The call details may be provided in one or more strings of reporting code. Preferably, the code contain fields that represent the data contained, such as, but not limited to, the Component Name, the bind name, and the Path IP address. These call details are received by the Call Tracker 110. The Call Tracker 110 parses the details of the request sends these details to the Call Logger 130 which then logs the Call Details.

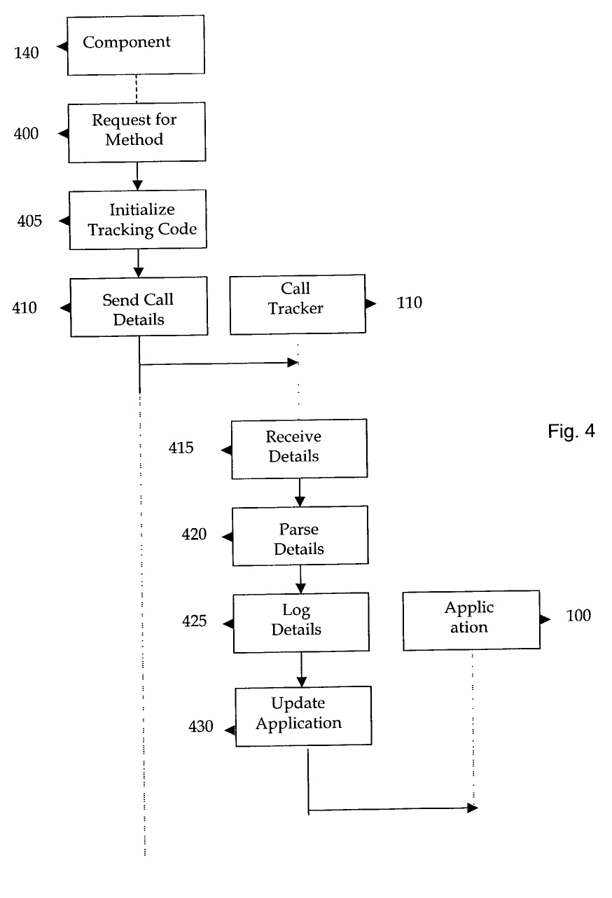

FIG. 4 illustrates another example of the Computing System 10 for tracking calls. In this embodiment, subscribing Software Component 140 requests a method or function from the Call Tracker 110. In doing so, the subscribing Software Component 140 initializes the tracking code. The tracking code enables information and details of the calls to be tracked and logged by the Call Logger 130. The tracking code compiles the information and generates a reporting code comprised of a string. The reporting code is a string containing details of the call being made to the Call Tracker 110. The Call Tracker 110 receives the reporting code string and parses the details.

During the parsing process, the Call Tracker 110 breaks the string into different fields and then matches the fields with a predetermined field structure. The Call Tracker 110 contacts the Call Tracker Logger 130 and provides the Call Logger 130 with the call details. The Call Logger 130 creates a log of the details. The Call Tracker 110 then updates the Application 100 and/or Software Component 140 of the successful tracking of the call.

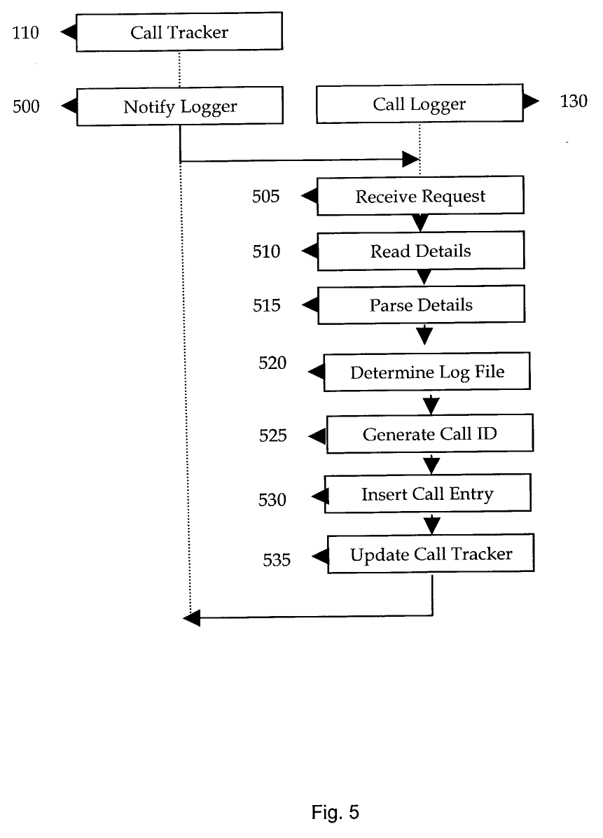

FIG. 5 illustrates one example for logging the tracked call. In this example, the Call Tracker 110 notifies the Call Logger 130 of a request to record or log calls. The Call Tracker 110 notifies the Call Logger 130 of the request for a call to be tracked. The Call Logger 130 receives the request to log the calls and reads the details of the Call. The Call Logger 130 parses the call details and selects a Log File to record the call information. Once the Call Logger 130 selects a Log File, the Call Logger 130 creates a call identification or profile and inserts the call entry information into the Log File. The Call Logger 130 transmits a message to the Call Tracker 100 and notifies the Call Tracker 110 of the successful logging of the call.

Information or data regarding the tracked calls can be retrieved from the Call Logger 130. In obtaining data regarding the tracked calls, the Application 100 or user can request specific tracking information to locate the information such as a particular date range, a selected component, or a desired method or function performed. The user or application can retrieve component data.

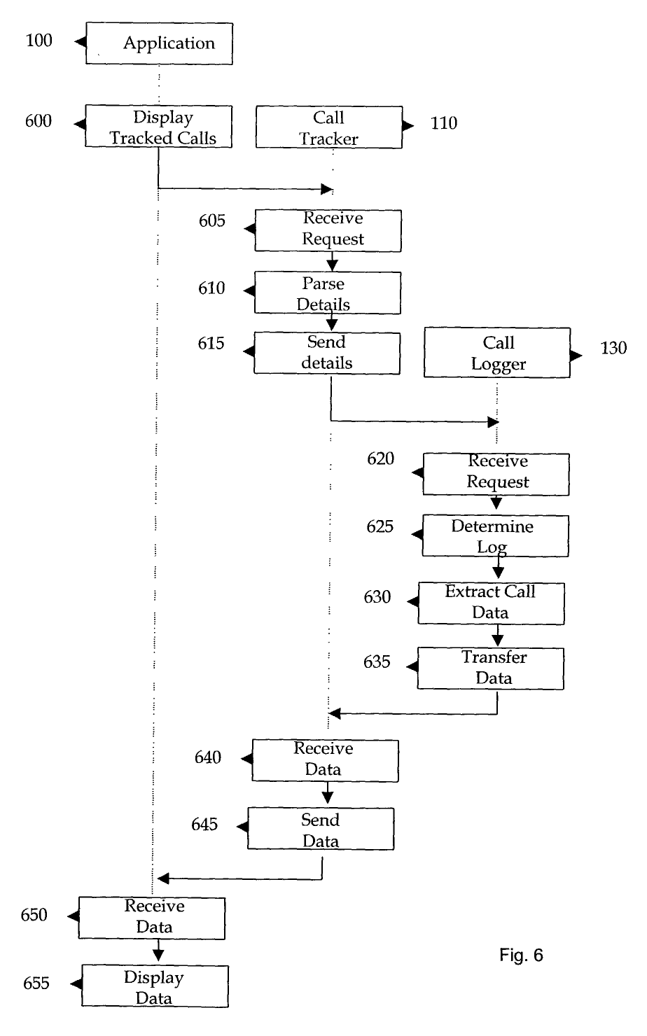

As illustrated in FIG. 6, the Application 100 and or interfacing device displays the tracked calls enabling a user to view and select a component to manipulate. Once the user or application selects which component whose call details is desired to be displayed and sends the request to the Call Tracker 110. The Call Tracker 110 parses the details of the components. The parsed details are sent to the Call Logger 130. The Call Logger 130 extracts the call data from a selected Log file and transfers the extracted data to the Call Tracker 110. The Call Tracker 110 receives the data and sends the data to the Application 100. The Application 100 receives the information and displays the information to the user using a user interface.

What is claimed is:

1. A computing system capable of tracking computer calls, the computing system comprising:
a. a call tracker;
b. a code generator responsive to the call tracker, the code generator configured to generate computer tracking code and to provide the tracking code to the call tracker;
c. a software component responsive to the call tracker, the software component configured by the tracking code to extract predetermined call details and to provide a reporting code including the call details to the call tracker; and
d. a call logger responsive to the call tracker, the call logger configured to store call details.

2. The computing system of claim 1, wherein the computing system comprises a single computer.

3. The computing system of claim 1, wherein the computing system comprises a plurality of computers and a computer network connecting the plurality of computers.

4. The computing system of claim 1, wherein the computing system further comprises a software application in communication with the call tracker and with the software component, wherein the software component is responsive to the call tracker via the software application.

5. The computing system of claim 1, wherein the code generator is configured to generate a tracking code in a language corresponding to that of the selected software component.

6. The computing system of claim 1, wherein the software component is a subscribing component.

7. The computing system of claim 1, wherein the software component is further configured to make a call on a publishing component.

8. The computing system of claim 1, wherein the reporting code provided by the software component includes call details including a function requested by the software component.

9. The computing system of claim 1, wherein the reporting code provided by the software component includes a component name, a bind name, and an address.

10. The computing system of claim 1, wherein the call tracker parses the reporting code and sends the call details to the call logger.

11. The computing system of claim 1, wherein the software component comprises a plurality of software components.

12. A method of tracking computer call requests between a plurality of software components in a computing system, the method comprising:
a. configuring the computing system to include:
1. a call tracker;
2. a code generator responsive to the call tracker;
3. a call logger responsive to the call tracker; one or more software components.
b. selecting a software component call for tracking;
c. sending component details of the selected software component to the call tracker;
d. the call tracker parsing the component details and invoking the code generator;
e. the code generator generating a tracking code to extract call details made by the selected component and to provide a reporting code;
f. the code generator sending the tracking code to the call tracker;
g. the call tracker installing the tracking code in the selected software component; and
h. the software component reporting call details to the call tracker via the reporting code.

13. The method of claim 12 further comprising the steps of:
a. the call tracker providing the call details to the all logger, and
b. the call logger logging tracked call details in a storage repository.

14. The method of claim 13, further comprising the steps of:
a. the call logger parsing the call details;
b. the call logger creating a unique call identification;
c. the call logger storing the unique call identification.

15. The method of claim 14, wherein the call identification includes a name of the selected software component, a name of a called software component, and a name of a requested function.

16. The method of claim 12 wherein the step of selecting a software component comprises the call tracker;
a. searching for components;
b. reading details of registered software components; and
c. providing details of selected components to the call logger.

17. The method of claim 12, wherein the call tracker;
a. sends a tracking code to the selected component;
b. receives a reporting code containing details of the component;
c. parses the details of the reporting code and sends the information to a storage mechanism via a call logger.

18. The method of claim 12 wherein the step of selecting a software component is performed by the call tracker without user input.

19. The method of claim 12 wherein the call generator:
a. generates a tracking code configured to extract call details
b. generates a recording code containing the call details

20. The method of claim 12, further comprising the steps of:
a. selecting the storage repository to retrieve the desired information;
b. retrieving logged calls from a storage repository;
c. determining the call data to extract; and
d. extracting the call data from the storage repository.
